(19) United States
(12) Patent Application Publication
(10) Pub. No.: US 2014/0270932 A1
(43) Pub. Date: Sep. 18, 2014

(54) Modular Furniture Part

(71) Applicant: TAIWAN SHIN YEH ENTERPRISE CO., LTD., Chiayi Hsien (TW)

(72) Inventor: Chuen-Jong Tseng, Chiayi Hsien (TW)

(73) Assignee: TAIWAN SHIN YEH ENTERPRISE CO., LTD., Chiayi Hsien (TW)

(21) Appl. No.: 13/795,690

(22) Filed: Mar. 12, 2013

(51) Int. Cl. F16B 1/00

(52) U.S. Cl. CPC F16B 1/00
USPC 403/345

(57) ABSTRACT

A modular furniture part includes a pair of frame bars, a plurality of board strips and a pair of frame connecting parts. The frame bars are spaced apart from each other and are each formed with a mounting groove that extends along a longitudinal direction. The board strips are arranged in parallel along the longitudinal direction, extend between and are mounted separably to the mounting grooves of the frame bars. The frame connecting parts are spaced apart from each other, are to be mounted to a furniture frame, and are formed with slide grooves that slidably and removably receive the frame bars.

### BACKGROUND OF THE INVENTION

1. Field of the Invention

The present invention relates to a modular furniture part, more particularly to a modular furniture part that facilitates replacement of components thereof.

2. Description of the Related Art

A furniture part, such as a tabletop, a seat or backrest of a chair, etc., is generally inseparable from an associated piece of furniture. Therefore, once the furniture part is soiled or damaged, the user may decide to simply store or even discard the entire piece of furniture since replacement of the soiled or damaged furniture part is not possible, thereby incurring unnecessary waste or additional cost of purchasing a new piece of furniture.

### SUMMARY OF THE INVENTION

Therefore, an object of the present invention is to provide a modular furniture part that facilitates replacement of components thereof to alleviate the above drawbacks of the prior art.

According to the present invention, a modular furniture part is adapted for mounting on a furniture frame and comprises a pair of frame bars, a plurality of board strips and a base unit. The frame bars are spaced apart from each other. Each of the board strips extends between and is mounted separably to the frame bars. The base unit is adapted to be mounted to the furniture frame and is configured to engage removably the frame bars.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a piece of furniture provided with a pair of modular furniture parts according to the present invention;

FIG. 2 is a partly exploded fragmentary perspective view of a first preferred embodiment of the modular furniture part according to the present invention;

FIG. 3 is a longitudinal sectional view of the first preferred embodiment of the modular furniture part according to the present invention;

FIG. 4 is a transverse fragmentary sectional view of the first preferred embodiment of the modular furniture part according to the present invention;

FIG. 5 is a partly exploded fragmentary perspective view of a second preferred embodiment of the modular furniture part according to the present invention; and

FIG. 6 is a longitudinal sectional view of the second preferred embodiment of the modular furniture part according to the present invention.

### DETAILED DESCRIPTION OF THE PREFERRED EMBODIMENTS

Before the present invention is described in greater detail, it should be noted that like elements are denoted by the same reference numerals throughout the disclosure.

Referring to FIG. 1, the first preferred embodiment of a modular furniture part 2 according to the present invention is shown to be adapted for mounting on a furniture frame 11 of apiece of furniture 1. In this preferred embodiment, the piece of furniture 1 is a chair and the modular furniture part 2 is a chair seat. In other embodiments of the present invention, the piece of furniture 1 may be a table, a desk, a cabinet, etc., and the modular furniture part 2 maybe a tabletop, a backrest, a shelf, etc. The present invention should not be limited to the disclosure of this preferred embodiment.

Referring to FIGS. 2, 3 and 4, the modular furniture part 2 of this embodiment is shown to include a pair of frame bars 3, a plurality of board strips 4, a plurality of connecting components 5, a pair of frame connecting parts 6 that serve as a base unit, and a sleeve component 7. Since one side of the modular furniture part 2 showing one of the frame connecting parts 6 is symmetric to the other side of the modular furniture part 2 showing the other one of the frame connecting parts 6, only one of the two sides of the modular furniture part 2 is illustrated in FIGS. 2 to 6.

The frame bars 3 are spaced apart from each other, and are formed respectively with a mounting groove 35 that extends along a longitudinal direction. Each of the frame bars 3 includes a base wall 31, a side wall 32, a plurality of dividers 33, and an end wall 34. The base wall 31 has a longitudinal edge distal from the other one of the frame bars 3. The side wall 32 extends perpendicularly from the longitudinal edge of the base wall 31. The base wall 31 and the side wall 32 cooperate to define the mounting groove 35. The dividers 33 are spaced apart from each other in the longitudinal direction and extend from one of the base wall 31 and the side wall 32 to divide the mounting groove 35 into a plurality of groove portions 351. The end wall 34 is disposed to close one of two ends of the mounting groove 35, which is adjacent to the furniture frame 11 of the piece of furniture 1 in this preferred embodiment. The base wall 31 is formed with pairs of screw holes 311 in spatial communication with the groove portions 351, respectively. In this preferred embodiment, each of the frame bars 3 is made by plastic injection molding. It is understood that each of the frame bars 3, without being limited to this preferred embodiment, may include a pair of the end walls 34 disposed respectively to close two ends of the mounting grooves 35, each of the frame bars 3 may be made using other materials or means, and the number of the screw holes 311 may be different in other embodiments of the present invention.

Each of the board strips 4 extends between and is mounted separably to the frame bars 3. In this preferred embodiment, the board strips 4, which may be formed in different shapes in other embodiments of the present invention, are arranged in parallel along the longitudinal direction with respect to the frame bars 3. Each of the board strips 4 has a pair of mounting end portions 41 opposite to each other in a transverse direction transverse to the longitudinal direction. Each of the mounting end portions 41 is mounted separably to a respective one of the frame bars 3 in the mounting groove 35 of the respective one of the frame bars 3. In this preferred embodiment, the board strips have a uniform cross-section in the transverse direction. Each of the mounting end portions 41 is mounted fittingly in a respective one of the groove portions 351 of the frame bars 3. Each of the mounting end portions 41 is formed with a pair of through holes 411 that extend through the mounting end portion 41 in a vertical direction transverse to the longitudinal direction and the transverse direction, and that correspond to a respective pair of the screw holes 311 of the base wall 31 of the respective frame bar 3. It is understood that the number of the through holes 411 may vary in other embodiments of the present invention. In addition, the dividers 33 may be omitted in other embodiments, so that the board strips 4 may be disposed closely adjacent to each other. Moreover, the board strips 4 in this preferred embodiment are made by plastic injection molding, but may be made using metal boards or wooden boards in other embodiments of the present invention.

The number of the connecting components 5 is equal to that of the through holes 411. Each of the connecting components 5 in this preferred embodiment is a screw that extends through one of the through holes 411 of the mounting end portions 41 of one of the board strips 4 and that is screwed into one of the screw holes 311 of one of the frame bars 3 for fastening removably the board strip 4 to the frame bar 3. It is noted that each of the connecting components 5 may be an insert pin, and each of the screw holes 311 may be replaced with a pin groove. The present invention is not limited to the configurations of the connecting components 5, the screw holes 311 and the through holes 411 used in this embodiment as long as the connecting components 5 are able to fasten removably the board strips 4 to the frame bars 3.

The frame connecting parts 6 are spaced apart from each other and are adapted to be mounted to the furniture frame 11. Each of the frame connecting parts 6 is formed with a slide groove 61 that slidably and removably receives a respective one of the frame bars 3. Each of the slide grooves 61 has an open side 611 to permit extension of the board strips 4 therethrough. Each of the open sides 611 has a length in the vertical direction shorter than that of the frame bars 3 so as to prevent the frame bars 3 from escaping therethrough. Each of the frame connecting parts 6 has a mounting end to be disposed proximate to the furniture frame 11 and a distal end opposite to the mounting end. In this preferred embodiment, each of the mounting ends of the frame connecting parts 6 is blocked by the furniture frame 11 so that the respective one of the frame bars 3 is unable to exit from the mounting end. The frame connecting part 6 is made by extrusion molding of aluminum or aluminum alloy, but the present invention is not limited in this respect.

The sleeve component 7 extends between and is sleeved removably on the distal ends of the frame connecting parts 6. The sleeve component 7 covers the distal ends of the frame connecting parts 6 to conceal the frame bars 3, thereby improving the aesthetic appeal of the piece of furniture 1. In this preferred embodiment, the sleeve component 7 is made by plastic injection molding, but may be made using other materials or means in other embodiments of the present invention.

To assemble the modular furniture part 2, the board strips 4 are disposed between the pair of frame bars 3 with each of the mounting end portions 41 mounted separably to a respective one of the frame bars 3 in the respective ones of the groove portions 351 using the connecting components 5. Then, the assembled frame bars 3 and board strips 4 are slid along the longitudinal direction into the pair of frame connecting parts 6 which are already mounted fixedly to the furniture frame 11. Finally, the sleeve component 7 is sleeved removably on the distal ends of the frame connecting parts 6.

Each of the board strips 4 may be removed and replaced by reversing the order of the above-mentioned steps when a particular one of the board strips 4 is soiled or damaged. Specifically, the first step is to disassemble the sleeve component 7, the second step is to remove the frame bars 3 and the board strips 4 from the frame connecting parts 6, and the last step is to remove and replace the desired board strip 4.

Referring to FIGS. 5 and 6, the second preferred embodiment of the modular furniture part 2 according to the present invention is similar to the first preferred embodiment. The only difference resides in that the dividers 33 of the first preferred embodiment are omitted in this preferred embodiment. In other words, the board strips 4 are disposed closely adjacent to each other. Specifically, each of the board strips 4 has opposite first and second edge parts that extend in the transverse direction. The first edge part is formed with a first abutting flange 413, and the second edge part is formed with a second abutting flange 414. Each of the first abutting flanges 413 is staggered with each of the second abutting flanges 414 in the vertical direction. Therefore, each of the board strips 4 has a substantially Z-shaped cross-section in the transverse direction. It is understood that the shape of the cross-section of the board strips 4 should not be limited to the disclosure of this preferred embodiment.

To assemble the modular furniture part 2, the second abutting flange 414 of one of the board strips 4 is disposed to abut against the first abutting flange 413 of an adjacent one of the board strips 4 in a stack manner. The board strips 4 are then mounted between the frame bars 3 without requiring the use of the connecting components 5. The rest of the assembly steps are the same as those described in the first preferred embodiment, and are omitted herein for the sake of brevity.

To conclude, the modular furniture part 2 according to the present invention facilitates removal of components thereof from the furniture frame 11 so that a desired one of the board strips 4 may be removed and replaced when needed. Therefore, unnecessary waste and additional cost of purchasing a new piece of furniture 1 may be avoided.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A modular furniture part adapted for mounting on a furniture frame, said modular furniture part comprising:
a pair of frame bars spaced apart from each other;
a plurality of board strips, each extending between and being mounted separably to said frame bars; and
a base unit adapted to be mounted to the furniture frame and configured to engage removably said frame bars.

2. The modular furniture part as claimed in claim 1, wherein each of said frame bars is formed with a mounting groove that extends along a longitudinal direction, and each of said board strips has a pair of mounting end portions opposite to each other in a transverse direction transverse to the longitudinal direction, each of said mounting end portions being mounted separably to a respective one of said frame bars in said mounting groove of the respective one of said frame bars.

3. The modular furniture part as claimed in claim 2, wherein said board strips are arranged in parallel along the longitudinal direction with respect to said frame bars.

4. The modular furniture part as claimed in claim 2, wherein each of said frame bars includes a base wall having a longitudinal edge distal from the other one of said frame bars, and a side wall that extends perpendicularly from said longitudinal edge of said base wall, said base wall and said side wall cooperating to define said mounting groove.

5. The modular furniture part as claimed in claim 4, wherein each of said frame bars further includes a plurality of dividers that are spaced apart from each other in the longitudinal direction and that extend from one of said base wall and said side wall to divide said mounting groove into a plurality of groove portions, each of said groove portions receiving a respective one of said mounting end portions of said board strips.

6. The modular furniture part as claimed in claim 4, wherein each of said board strips has opposite first and second edge parts that extend in the transverse direction, said first edge part being formed with a first abutting flange, said second edge part being formed with a second abutting flange staggered with said first abutting flange in a direction transverse to the longitudinal and transverse directions, said second abutting flange of one of said board strips abutting against said first abutting flange of an adjacent one of said board strips in a stack manner.

7. The modular furniture part as claimed in claim 2, wherein each of said frame bars has an end wall disposed to close one end of said mounting groove.

8. The modular furniture part as claimed in claim 1, further comprising a plurality of connecting components to fasten removably said board strips to said frame bars.

9. The modular furniture part as claimed in claim 8, wherein each of said connecting components is a screw.

10. The modular furniture part as claimed in claim 1, wherein said base unit is formed with a pair of slide grooves that slidably and removably receive said frame bars, respectively.

11. The modular furniture part as claimed in claim 10, wherein said base unit includes a pair of frame connecting parts that are spaced apart from each other and adapted to be mounted to the furniture frame, each of said frame connecting parts being formed with a respective one of said slide grooves, each of said slide grooves having an open side to permit extension of said board strips therethrough.

12. The modular furniture part as claimed in claim 11, wherein each of said frame connecting parts has a mounting end to be disposed proximate to the furniture frame and a distal end opposite to said mounting end, said modular furniture part further comprising a sleeve component extending between and sleeved removably on said distal ends of said frame connecting parts.

13. The modular furniture part as claimed in claim 1, wherein said board strips have a uniform cross-section in the transverse direction.

14. A modular furniture part adapted for mounting on a furniture frame, said modular furniture part comprising:
a pair of frame bars spaced apart from each other, each of said frame bars being formed with a mounting groove that extends along a longitudinal direction;
a plurality of board strips, each having a pair of mounting end portions opposite to each other in a transverse direction transverse to the longitudinal direction, each of said mounting end portions being mounted separably to a respective one of said frame bars in said mounting groove of the respective one of said frame bars, said board strips being arranged in parallel along the longitudinal direction with respect to said frame bars; and
a pair of frame connecting parts spaced apart from each other and adapted to be mounted to the furniture frame, each of said frame connecting parts being formed with a slide groove that slidably and removably receives a respective one of said frame bars, each of said slide grooves having an open side to permit extension of said board strips therethrough.

15. The modular furniture part as claimed in claim 14, wherein each of said frame bars includes a base wall having a longitudinal edge distal from the other one of said frame bars, and a side wall that extends perpendicularly from said longitudinal edge of said base wall, said base wall and said side wall cooperating to define said mounting groove.

16. The modular furniture part as claimed in claim 15, wherein each of said frame bars further includes a plurality of dividers that are spaced apart from each other in the longitudinal direction and that extend from one of said base wall and said side wall to divide said mounting groove into a plurality of groove portions, each of said groove portions receiving a respective one of said mounting end portions of said board strips.

17. The modular furniture part as claimed in claim 15, wherein each of said board strips has opposite first and second edge parts that extend in the transverse direction, said first edge part being formed with a first abutting flange, said second edge part being formed with a second abutting flange staggered with said first abutting flange in a direction transverse to the longitudinal and transverse directions, said second abutting flange of one of said board strips abutting against said first abutting flange of an adjacent one of said board strips in a stack manner.
